(19) United States
(12) Patent Application Publication
(10) Pub. No.: US 2006/0129459 A1
(43) Pub. Date: Jun. 15, 2006

(54) Method and system for the secure distribution of software via a communications network

(76) Inventor: Mark Philip Mendelsohn, San Marcos, CA (US)

Correspondence Address: MCANDREWS HELD & MALLOY, LTD, 500 WEST MADISON STREET, SUITE 3400, CHICAGO, IL, 60661, US

(21) Appl. No.: 10/997,388

(22) Filed: Nov. 22, 2004

(51) Int. Cl. G06Q 30/00

(52) U.S. Cl. 705/26

(57) ABSTRACT

Aspects for distributing software via a network may comprise requesting user identification utilized for tracking an online software order. A pickup code associated with the online software order may be generated. Downloads associated with the online software order may be tacked based on at least the pickup code and/or an activation code. Downloads may be terminated based on fulfilling delivery of all of the online software order based on the tracking.

### CROSS-REFERENCE TO RELATED APPLICATIONS/INCORPORATION BY REFERENCE

Not Applicable.

### FIELD OF THE INVENTION

Certain embodiments of the invention relate to distributing software via a communications network. More specifically, certain embodiments of the invention relate to a method and system for distributing software via a communications network.

### BACKGROUND OF THE INVENTION

Conventional methods of distributing software over the Internet may comprise a plurality of steps. A user may logon to a universal resource locator (URL) to access a web site on the world wide web (WWW). Next, a user may choose a software item which is to be downloaded to the user. At “checkout”, the user may be prompted to indicate a method of payment for downloading of the chosen software item, after which the software item may be downloaded as requested by the user.

Downloading of software items which are delivered over a network may account for a significant portion of the time required to fulfill a software order. Furthermore, web sites which may provide unrestricted access on the Internet may be prone to attack by hackers who may be capable of anonymously accessing the web site. Hackers may succeed in completing unauthorized downloads of software items, or in effecting the replacement of a software item at a web site with a corrupted version which may propagate a computer virus.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention provide a method and system for distributing software via a network. Aspects of the method may comprise requesting user identification utilized for tracking an online software order and generating a pickup code associated with the online software order. The method may further comprise tracking downloads associated with the online software order based on at least one of either a pickup code or an activation code. In addition, the downloads may be terminated upon fulfilling delivery of all of the online software order based on tracking. Delivery of at least a portion of the online software order may also be terminated if at least a portion of the online software order is not downloaded in a determined period of time.

The method may further comprise suspending delivery of at least a portion of the online software order after receiving a suspension request. A delivery status of at least a portion of the online software order may be maintained upon receiving a suspension request. Delivery of at least a portion of the online software order may be resumed upon receiving a resumption request. Other aspects of the method may comprise receiving an online software order, that comprises a quantity associated with at least one software item. Download of at least a portion of an online software order may be authorized based at least on a pickup code. A quantity of software items associated with the online software order may be adjusted after delivering at least one software item, which is a part of the online software order. The method may also comprise authorizing download of an online software order from a plurality of locations. A subsequent download of a software item in an online software order may be authorized if download of a portion of the same online software order has failed. An activation code may be generated upon initiation of delivery of at least a portion of an online software order. Access to a secured download location may be terminated upon fulfilling delivery of all of an online software order.

Another embodiment of the invention may provide a machine-readable storage, having stored thereon, a computer program having at least one code section executable by a machine, thereby causing the machine to perform the steps as described above for distributing software via a network.

Aspects of a system for distributing software via a network may comprise at least one processor which requests user identification utilized for tracking an online software order. The at least one processor may generate a pickup code associated with the online software order and track downloads associated with an online software order based on at least one of either the pickup code or an activation code. In addition, the processor may be adapted to terminate the downloads upon fulfilling delivery of all of the online software based on tracking. The processor may terminate delivery of at least a portion of the online software order, if at least a portion of the online software order is not downloaded in a determined period of time.

The processor may be adapted to suspend delivery of at least a portion of the online software order after receiving a suspension request. A delivery status of at least a portion of the online software order may be maintained upon receiving a suspension request. The processor may be adapted to resume delivery of at least a portion of the online software order upon receiving a resumption request. The processor may receive the online software order, which may comprise a quantity associated with at least one software item. The processor may be adapted to authorize download of at least a portion of the online software order based at least on a pickup code and a quantity of software items associated with an online software order may be adjusted by the processor after delivering at least one software item, which comprises the online software order. The processor may be adapted to authorize download of the online software order from a plurality of locations. A subsequent download of a software item in the online software order may be authorized by the processor if download of a portion of the same online software order has failed. The processor may generate an activation code upon initiation of delivery of at least a portion of an online software order. The processor may be adapted to terminate access to a secured download location upon fulfilling delivery of all of an online software order.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for distributing software via a network in accordance with an embodiment of the invention.

FIG. 2 is a flowchart illustrating exemplary steps for selection and authorization to access a software item in accordance with an embodiment of the invention.

FIG. 3A is a flowchart illustrating exemplary steps for download, installation, and activation of a software item in accordance with an embodiment of the invention.

FIG. 3B is a flowchart illustrating exemplary steps for validating authorization to activate a software item in accordance with an embodiment of the invention.

### DETAILED DESCRIPTION OF THE INVENTION

Certain embodiments of the invention may be found in a method and system for distributing software via a network. Various aspects of the invention may be utilized in a manner, which may allow, for example, end-users and enterprise supporting Information Technology (IT) groups to obtain new and/or updated software securely over a network such as the Internet. In an embodiment of the invention, aspects for distributing software via a network may comprise requesting user identification utilized for tracking an online software order. A pickup code associated with the online software order may be generated. Downloads associated with the online software order may be tacked based on at least the pickup code and/or an activation code. Downloads may be terminated based on fulfilling delivery of all of the online software order based on the tracking.

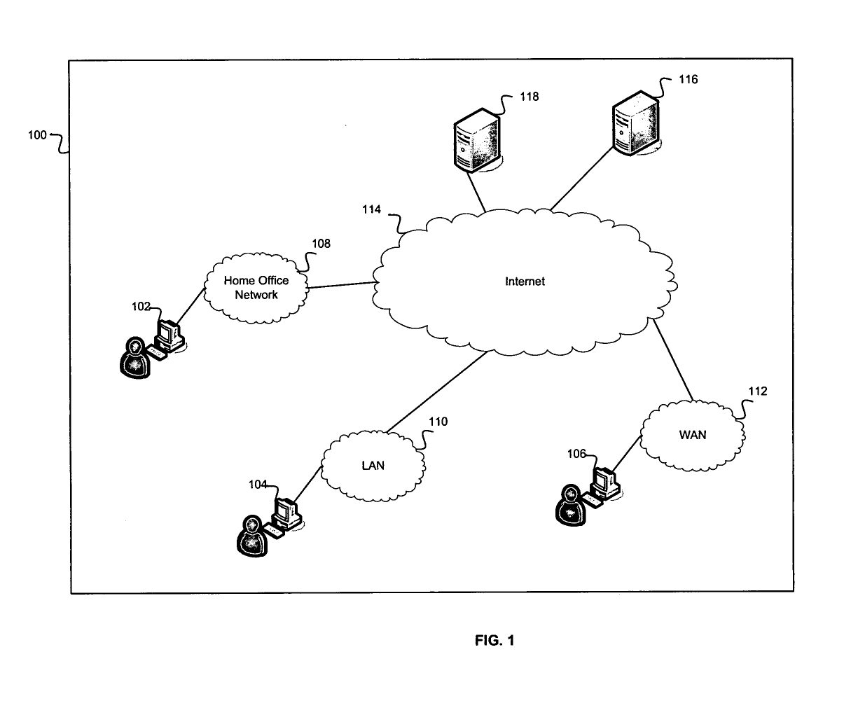

FIG. 1 shows a block diagram of an exemplary system for distributing software via a network in accordance with an embodiment of the invention. Referring to FIG. 1 a system for distributing software via a network 100 may comprise a plurality of networks 108, 110, 112, and 114, a server 116, a third party server 118, and a plurality of user devices 102, 104, 106. End users may be stationed at user devices 102,104, 106, the network 108 may be a home office network, the network 110 may be a Local Area Network (LAN), the network 112 may be a Wide Area Network (WAN), and network 114 may be the Internet, for example.

The user device 102 may be, for example, a computing device such as a PC, laptop, workstation, or a hand-held type device such as a personal digital assistant (PDA) or cell phone, or some combination thereof. The user device 102 may be part of the home office network 108, which has the capability to access the Internet 114. The Internet 114 may have the capability to provide access to the server 116. The server 116 may have the capability to facilitate download of a software item over any of the networks 108, 110, 112, 114. The home office network 108 may have the capability to provide access to server 116. Physical connections, or attachments, between user device 102 and home office network 108 may utilize wired and/or wireless technologies, such as 802.11 or Bluetooth, for example. Furthermore, the physical connections between server 116 and any of the networks 108, 110, 112, 114 may also utilize wired and/or wireless technologies. Similarly, physical connections between home office network 108 and the Internet 114 may also employ wired and/or wireless technologies. The user device 102 may also provide a human interface, for example a graphical user interface (GUI), to end users which allows an end user to place an online software order and/or initiate a request that may prompt server 116, upon receipt of the request, to download software to user device 102 over at least one of network 108, 114.

The user device 104 may be, for example, a computing device such as a PC, laptop, workstation, or a hand-held type device such as a PDA or cell phone, or some combination thereof. The user device 104 may be part of LAN 110, which has the capability to access the Internet 114. The Internet 114 may have the capability to provide access to the server 116. The server 116 may have the capability to facilitate download of a software item over any of the networks 108, 110, 112, 114. The LAN 110 may have the capability to provide access to server 116. Physical connections, or attachments, between user device 104 and LAN 110 may utilize wired and/or wireless technologies, such as 802.11 or Bluetooth, for example. Furthermore, the physical connections between server 116 and any of the networks 108, 110, 112, 114 may also utilize wired and/or wireless technologies. Similarly, physical connections between LAN 110 and the Internet 114 may also employ wired and/or wireless technologies. The user device 104 may also provide a human interface, for example a GUI, to end users which allows an end user to place an online software order and/or initiate a request that may prompt server 116, upon receipt of the request, to download software to user device 104 over at least one of network 110, 114.

The user device 106 may be, for example, a computing device such as a PC, laptop, workstation, or a hand-held type device such as a PDA or cell phone, or some combination thereof. The user device 106 may be part of WAN 112, which has the capability to access the Internet 114. The Internet 114 may have the capability to provide access to the server 116. The server 116 may have the capability to facilitate download of a software item over any of the networks 108, 110, 112, 114. The WAN 112 may have the capability to provide access to server 116. Physical connections, or attachments, between user device 106 and WAN 112 may utilize wired and/or wireless technologies, such as 802.11 or Bluetooth, for example. Furthermore, the physical connections between server 116 and any of the networks 108, 110, 112, 114 may also utilize wired and/or wireless technologies. Similarly, physical connections between WAN 112 and the Internet 114 may also employ wired and/or wireless technologies. The user device 106 may also provide a human interface, for example a GUI, to end users which allows an end user to place an online software order and/or initiate a request that may prompt server 116, upon receipt of the request, to download software to user device 106 over at least one of network 112,114.

The server 116 may comprise a plurality of communication devices which provide services related to the distribution of software via a network to a user device 102, 104, or 106. These services may comprise receiving online software orders from a user device 102, 104, 106. Services may also comprise requesting user identification from users of a user device 102, 104, 106. Furthermore, services may comprise the downloading of software items to a user device 102, 104, 106. Additional services may comprise tracking of downloads of software items associated with an online software order, and the termination of downloads upon fulfilling delivery of all software items comprising an online software order. Services related to the distribution of software via a network may entail the establishment of a secure communications path between server 116 and a user device 102, 104, 106 over a network 108, 110, 112, 114.

Server 118 may comprise a plurality of communication devices with capabilities similar to those of server 116. The party authorized to administer and operate server 118 may be different from the party authorized to administer and operate server 116.

The invention may not be limited by the exemplary system shown in FIG. 1. Accordingly, a system for distributing software via a network may comprise one or more user devices 102, 104, 106, and server 116, being attached to a single network 108, 110, 112, 114, or a plurality of networks 108, 110, 112, 114. In addition, the invention may be applicable to other types of networks or devices which are not shown in FIG. 1.

In accordance with an embodiment of the invention, the method of distributing software via a network may comprise a plurality of stages. These stages may comprise a selection stage, an authorization stage, a download stage, an installation/activation stage, and an operation stage.

In the selection stage, the server 116, which is capable of distributing software via any one or more of networks 108, 110, 112, 114, may receive a request from a user employing a user device 102, 104, 106 to initiate communication. Upon establishing communication between the server 116 and any one of user devices 102, 104, 106, the server 116 may allow a user to select a desired software item and a quantity of that software item to be distributed by the server 116 to one or more of the user devices 102, 104, 106. The server 116 may cause a user interface to be presented on a user device 102, 104, 106, which may comprise a hierarchically organized web page from which a user may select a software item. In the selection stage a user may select a plurality of software items. The user interface presented by server 116 may also include presentation of a shopping cart, which may display, a summary of software items which have been selected by a user. The server 116 may record a software item selection by the user in a database based upon a unique identifier called a pickup code, which may be utilized to identify an online software order. An online software order may comprise a plurality of software items. The server 116 may also record the total quantity of software items which comprise an online software order.

In the authorization stage, the server 116 may be configured to request or prompt a user to provide software access entitlement information, which establishes that the user is entitled to access a software item, which may be downloaded from server 116. The entitlement information may comprise payment information, such as a credit card number and/or an expiration date. If the software access entitlement information is determined to be valid, server 116 may be adapted to store a pickup code on a user device 102, 104, 106. In addition, server 116 may display the pickup code in a web page displayed on any of user devices 102, 104, 106, which may be viewed by a user. If the software access entitlement information is not determined to be valid by server 116, a user may be denied access to download a software item from the server 116 and the online software order may be cancelled, thereby bringing the transaction to an end.

In the download stage the server 116 may be adapted to provide a secure download area, and a user may employ any one of user devices 102, 104, 106 to access a secure download area which may be maintained by the server 116. Whenever the user accesses the secure download area, the server 116 may prompt the user to enter the pickup code. After the user has entered the pickup code the server 116 may determine whether the pickup code is valid. If the pickup code is not valid, attempts to download the software item from server 116 may be denied. Consequently, the server 116 may display a message on a web page informing the user that access has been denied. If a pickup code entered by a user is valid, the software items comprising an online software order may be downloaded from server 116 to any one or more of user devices 102, 104, 106. Server 116 may permit a user to selectively download a software item to any one or more of user devices 102, 104, 106, constituent of an online software order which may be comprised of a plurality of software items.

In the installation/activation stage a software item which was downloaded from the server 116 to any one or more of user devices 102, 104, 106 in the download stage, may be placed in an operational state. In an operational state the capabilities inherent in a software item downloaded in the download stage may become available for utilization at a user device 102, 104, 106. During the installation/activation stage a user may be prompted by server 116 to choose manual or automatic activation of the software item at a user device 102, 104, 106. If a user selects automatic activation of a software item which has been downloaded, server 116 may establish a secure communication with a user device 102, 104, 106 which may be utilized to retrieve a pickup code and/or user ID (UID) without requesting manual intervention from a user. In this regard, automatic activation may require a pickup code to have previously been stored at a user device 102, 104, 106. The UID may be utilized by server 116 to uniquely identify a user device 102, 104, 106.

In an exemplary aspect of the invention, a UID may be based upon a physical address of a user device, for example. If a user selects manual activation, server 116 may provide the user with a universal resource locator (URL) associated with a web page. At the web page, which is referenced by the URL, a user may be prompted to provide contact information associated with the user's information that has been stored at the server 116, in addition to a pickup code and a UID. If a pickup code retrieved from any one or more of user devices 102, 104, 106 is valid, in the case of automatic activation, an activation code may be generated by the server 116 and stored on any one or more of user devices 102, 104, 106. If the user contact information/pickup code entered by a user at a web site is valid, in the case of manual activation, an activation code may be generated by the server 116 and stored on any one or more of user devices 102, 104, 106. Upon transfer of an activation code from the server 116, a software item downloaded during the download stage may become operational at a user device 102, 104,106.

During activation of a software item at any of the user devices 102, 104, 106, the server 116 may decrement a count associated with an online software order specifying a total quantity of items. The number by which the count may be decremented may be equal to a number of software items activated at a user device. If a pickup code retrieved from a user device 102, 104, 106 is not valid, in the case of automatic activation, or if the user contact information/pickup code entered by a user at a web site is not valid, in the case of manual activation, an activation code may not be generated by server 116 and stored on a user device 102, 104, 106. As a result, a software item downloaded during a download stage may be rendered in a non-operational state at a user device 102, 104, 106. In such case, a count associated with an online software order may not be modified.

In a hybrid method, a user may be directed to a web page on a third party server 118 at which the user may be prompted to enter information in a manner consistent with manual activation. The third party server 118 activates the software item at server 116 using a procedure consistent with automatic activation. In this case, the third party server 118 forwards the pickup code and/or UID associated with the user device to the server 116. The server 116 then returns the activation code to the third party server 118. The third party server 118 displays the activation code returned from server 116 on the web page.

In the operational stage a software item which had previously been downloaded to a user device, for example user device 102, may periodically read the UID associated the user device in order to determine whether the activation code is valid. The software item may re-encrypt the UID and compare it with the activation code stored at the user device. If the software item does not determine the activation code which is stored at the user device to be valid, the software item which is currently in an operational state on the user device may be placed into a non-operational state. This non-operational state will terminate the ability of the user device to utilize a capability inherent in a previously downloaded software item.

In an embodiment of the invention, the pickup code may be allowed to expire after a determined amount of time pursuant to the time at which the pickup code was generated. In such case, an attempt by a user to enter an expired pickup code during a transaction comprising a download stage may result in a denial of access to download a software item. If the count associated with an online software order is not greater than 0, the server 116 may determine that delivery of all software items comprising an online software order has been fulfilled. In such case, an attempt by a user, during a download stage, to enter a pickup code, for which a count associated with the attending online software order is 0, may result in a denial of access to download a software item.

In instances where a pickup code is valid, a user may be permitted to download a software item during a download stage to a plurality of user devices such as user devices 102, 104, 106 without a restriction on the number of such user devices for which software download access is requested. As such, an embodiment of the invention may not track the number of instances for which a software item has been downloaded during the download stage to a plurality of user devices 102, 104, 106. However, the invention may track the number of instances in which a software item previously downloaded to a plurality of user devices 102, 104, 106 has been activated during the installation/activation stage.

During the download stage, if a user enters a valid activation code for any of the user devices 102, 104, 106, the server 116 may download and activate a software item at any one of the user devices 102, 104, 106 without regard to the fulfillment status of an online software order. This feature enables a user to recover functionality inherent in a previously downloaded software item in the case of a failure occurring at a user device 102, 104, 106, which interferes with the ability of the user device 102, 104, 106 to utilize the features which inhere in a software item.

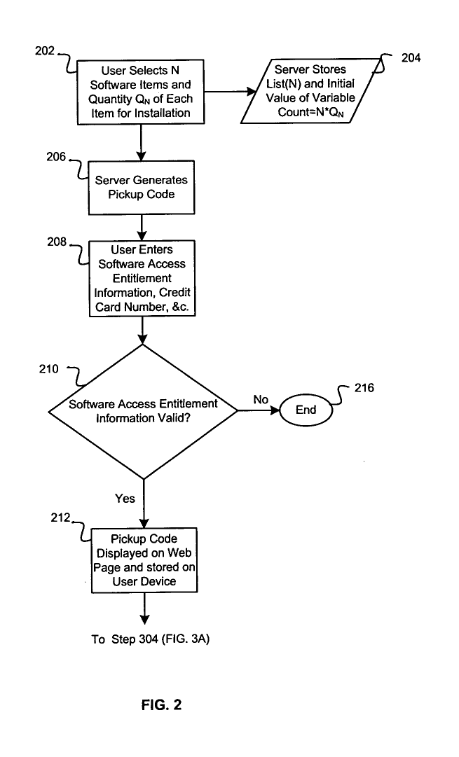

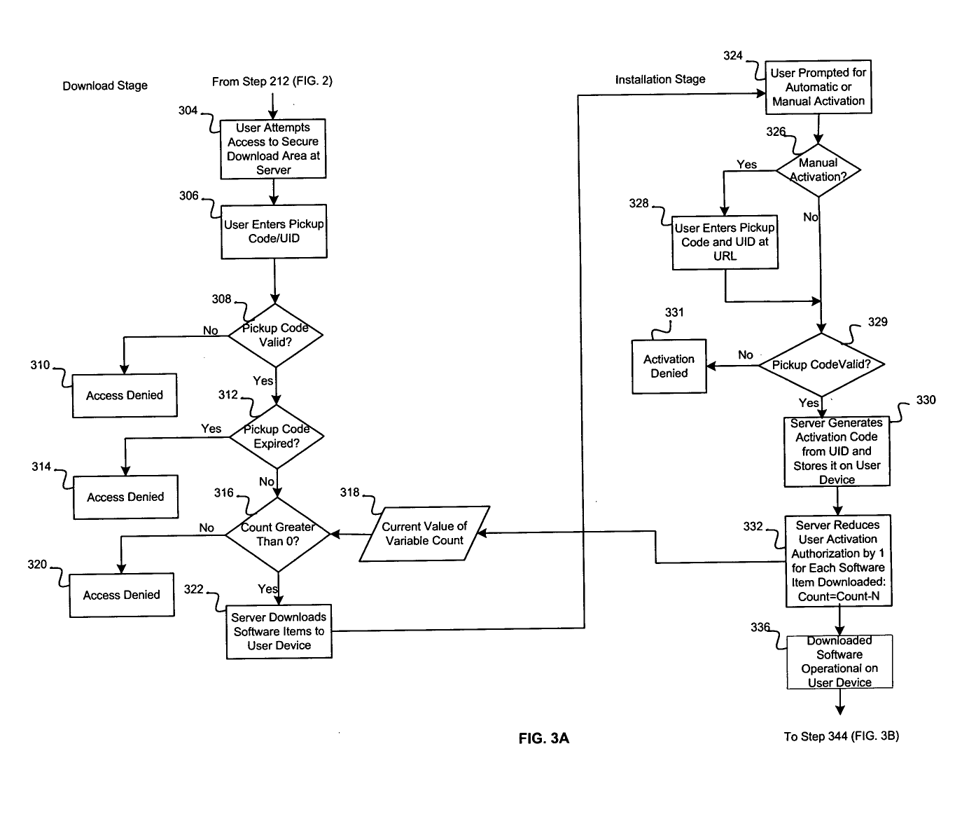

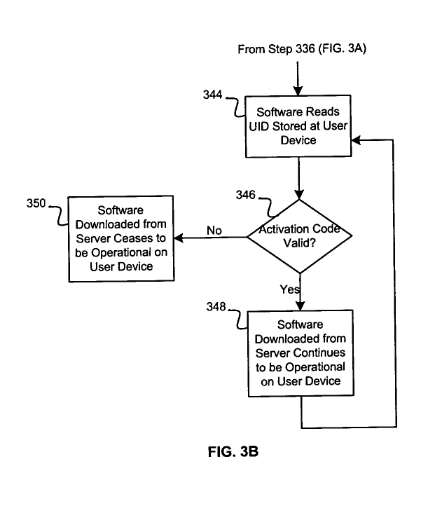

FIG. 2 is a flowchart illustrating exemplary steps in the selection and authorization stages of a system that may be utilized for distributing software via a network. In step 202 a user may select N software items and quantity Q_{N} of each item for installation. In step 204, server 116 stores list(N) and initial value of variable count=N*Q_{N}. In step 206, server 116 generates pickup code. In step 208, user enters software access entitlement information, for example, a credit card number. In step 210 it is determined whether the software access entitlement information valid. If the software access entitlement information is valid then, in step 212, a pickup code may be displayed on the web page and stored on a user device 102. Step 304 of FIG. 3A follows step 232. If the software entitlement information is not valid, then the steps may end at step 216.

With reference to FIG. 1 and FIG. 2, in step 202, a user may select N software items which comprises an online software order. For each software item, authorization is requested to activate a quantity Q_{N} of the software item on a user device 102. In step 204, the server 116 may store each requested software item in list(N), and may set a variable, count, which is equal to, N*Q_{N}, the total number of authorized activations of software items which comprise the online software order. In step 206, the server 116 generates a pickup code. In step 208, a user may enter information which entitles a user to access a software item on the server 116. Included in this information may be a credit card number to which charges associated with the fulfillment of an online software order may be charged. In step 210, the information entered in step 208 may be evaluated to determine whether a user will be authorized to download a software item from the server 116. If authorization is not granted at step 210, a transaction to download software items may end at step 216. If authorization is granted at step 210, a pickup code is displayed on a web page and stored on a user device 102, 104, 106.

FIG. 3A is a flowchart illustrating exemplary steps for download, installation, and activation of a software item in accordance with an embodiment of the invention. Referring to FIG. 3A, step 212 (FIG. 2) represents the completion of the selection and authorization stages which permits a user to proceed to the download and installation/activation stages which begins with step 304 which marks the beginning of the download stage, with the installation/activation stage subsequently beginning at step 324. In step 304, the user attempts access to secure download area at server 116. In step 306, the user enters pickupcode or UID. In step 308 it is determined whether the pickup code is valid. If the pickup code is not valid, then access may be denied in step 310. If the activation code is valid, then in step 312 it is determined whether the pickup code has expired. If the pickup code has expired, access may be denied in step 314. If the pickup code has not expired, then in step 316 it is determined whether the count is greater than 0. Step 318, which maintains the current value of variable count, is an input to step 316. If, in step 316, the value of count is not greater than 0, then access is denied in step 320. If the value of count is greater than 0, then, in step 322, the server downloads software items to a user device.

Next, in step 324, the user is prompted for automatic or manual activation. In step 326 it may be determined whether manual activation has been selected. If the user has selected manual activation, then in step 328, the user enters a pickup code and UID at a URL. If the user has not selected manual activation, then in step 329, it is determined whether the pickup code is valid. If the pickup code is not valid, then activation may be denied at step 331. If the pickup code is valid, then in step 330, the server generates an activation code and stores it on a user device. In step 332, the server reduces the user activation authorization by 1 for each software item downloaded (count=count−N). Step 336 and step 318 may follow step 332. In step 336, a downloaded software item may become operational on a user device.

Referring to FIG. 1 and FIG. 3, in step 304, the user may attempt to enter a secure download area on the server 116. In step 306 the user may enter a pickup code, which may identify an online software order, or a UID. In step 308 a determination may be made with respect to whether a pickup code entered in step 306 is valid. In step 308 if the pickup code is invalid, this may result in a denial of access to a secure download area as indicated in step 310. At step 312, it may be determined whether the pickup code entered in step 306 has expired. In step 312 if the pickup code has expired, this may result in a denial of access to a secure download area as indicated in step 314.

At step 316 a determination may be made as to whether the total number of software items which have been activated at any one or more of user devices 102, 104, 106 has reached the number of software item activations authorized under the online software order. The current value of the count variable may form a basis for a decision and is stored at server 116 with the current value of the count retrieved at step 318 each time a decision is made at step 316. In step 316, if the count is not greater than 0, this may result in a denial of access to a secure download area as shown in step 320. If the count is greater than 0, then at step 322 the server 116 may download a software item to the user device 102.

At step 324, a user may be permitted to configure a software item into an operational state at a user device 102. A user may be presented with two choices as to how a software item may be placed in an operational state at the user device 102, namely manual activation, or automatic activation. At step 326, the server 116 may make a decision based upon a response from a user at step 324. At step 328, a user may be presented with a web interface and prompted to enter a pickup code associated with an online software order, and a UID which is associated with the user device 102 if the user selected manual activation at step 326. If a user has selected automatic activation at step 326, the server 116 may retrieve a pickup code, and a UID from a user device 102, 104, 106 without intervention from a user.

At step 329, the server 116 may verify that a pickup code is valid. In step 329, if the pickup code is not valid, this may result in a denial of a request to activate a software item as shown in step 331. At step 330, the server 116 may configure a software item into an operational state at the user device 102. In addition, server 116 may generate an activation code, based upon a UID, and may store that activation code at the user device 102. In step 332, the server 116 may reduce the count variable associated with an online software order in a manner consistent with the number of software items which have been activated at a user device 102. In step 318, the current value of the count variable may be updated. In step 336, a software item may be configured in a operational state at a user device 102, 104, 106.

FIG. 3B is a flowchart illustrating exemplary steps for validating authorization to activate a software item in accordance with an embodiment of the invention. Referring to FIG. 3B, in step 344, the software item reads at the UID associated with a user device 102. Following step 344, in step 346 it is determined whether the activation code is valid. If the activation code is not valid, then at step 350, a software item downloaded from the server 116 ceases to be operational on a user device 102. If the activation code is valid, then in step 348, a software item downloaded from the server 116 may continue to be operational on a user device 102. Step 344 may follow step 348.

In step 344, a software item may read a UID at a user device such as 102, 104, or 106 in order to determine if the activation code stored at the user device is valid. In step 346, a software item may re-encrypt the UID in order to determine whether an activation code stored at, for example, user device 102, is valid. In step 346, if the activation code is valid, this may result in a software item being maintained in an operational state at a user device 102, 104, 106. In step 346, if the activation code is not valid, this may result in a software item being configured into a non-operational state at a user device 102, 104, 106.

An exemplary system for distributing software via a network in accordance with an embodiment of the invention may operate automatically without requiring manual intervention, and may prevent hackers from gaining access to the secure download area while ensuring that access to the download area is restricted to authorized, or identified users. The invention may permit enforcement of a limit on a number of instances of a software item which may be installed at one or more user devices. An embodiment of the invention may uniquely identify user devices to which a software item has been downloaded or activated, and may deter piracy of downloaded software items by enabling a software item at a user device to validate an activation code authorizing the operation of a software item on a particular user device. Benefits provided by the system may limit obligations to purveyors of software items by expiring an online software order after passage of a determined period of time, Another aspect of the invention may enable online distribution of software items for free trial periods by expiring the activation code at the end of the free trial period. Users who may wish to continue using the software item may obtain a new non-expiring activation code without downloading the software item once again.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for distributing software via a network, the method comprising:
requesting user identification utilized for tracking an online software order;
generating a pickup code associated with said online software order;
tracking downloads associated with said online software order based on at least one of said pickup code and an activation code; and
terminating said downloads upon fulfilling delivery of all of said online software order based on said tracking.

2. The method according to claim 1, further comprising terminating delivery of at least a portion of said online software order, if said at least a portion of said online software order is not downloaded in a determined period of time.

3. The method according to claim 1, further comprising suspending delivery of at least a portion of said online software order after receiving a suspension request.

4. The method according to claim 1, further comprising maintaining a delivery status of at least a portion of said online software order upon receiving a suspension request.

5. The method according to claim 1, further comprising resuming delivery of at least a portion of said online software order upon receiving a resumption request.

6. The method according to claim 1, further comprising receiving said online software order, wherein said online software order comprises a quantity associated with at least one software item.

7. The method according to claim 1, further comprising authorizing download of at least a portion of said online software order based on at least said pickup code.

8. The method according to claim 1, further comprising adjusting a quantity of software items associated with said online software order after delivering at least one software item, which is a part of said online software order.

9. The method according to claim 1, further comprising authorizing download of said online software order from a plurality of locations.

10. The method according to claim 1, further comprising authorizing a subsequent download of a software item in said online software order if download of a portion of said online software order is failed.

11. The method according to claim 1, further comprising generating said activation code upon initiation of delivery of at least a portion of said online software order.

12. The method according to claim 1, further comprising terminating access to a secured download location upon said fulfilling of said delivery of all of said online software order.

13. A machine-readable storage having stored thereon, a computer program having at least one code section for distributing software via a network, the at least one code section being executable by a machine for causing the machine to perform steps comprising:
requesting user identification utilized for tracking an online software order;
generating a pickup code associated with said online software order;
tracking downloads associated with said online software order based on at least one of said pickup code and an activation code; and
terminating said downloads upon fulfilling delivery of all of said online software order based on said tracking.

14. The machine-readable storage according to claim 13, further comprising code for terminating delivery of at least a portion of said online software order, if said at least a portion of said online software order is not downloaded in a determined period of time.

15. The machine-readable storage according to claim 13, further comprising code for suspending delivery of at least a portion of said online software order after receiving a suspension request.

16. The machine-readable storage according to claim 13, further comprising code for maintaining a delivery status of at least a portion of said online software order upon receiving a suspension request.

17. The machine-readable storage according to claim 13, further comprising code for resuming delivery of at least a portion of said online software order upon receiving a resumption request.

18. The machine-readable storage according to claim 13, further comprising code for receiving said online software order, wherein said online software order comprises a quantity associated with at least one software item.

19. The machine-readable storage according to claim 13, further comprising code for authorizing download of at least a portion of said online software order based on at least said pickup code.

20. The machine-readable storage according to claim 13, further comprising code for adjusting a quantity of software items associated with said online software order after delivering at least one software item, which is a part of said online software order.

21. The machine-readable storage according to claim 13, further comprising code for authorizing download of said online software order from a plurality of locations.

22. The machine-readable storage according to claim 13, further comprising code for authorizing a subsequent download of a software item in said online software order if download of a portion of said online software order is failed.

23. The machine-readable storage according to claim 13, further comprising code for generating said activation code upon initiation of delivery of at least a portion of said online software order.

24. The machine-readable storage according to claim 13, further comprising code for terminating access to a secured download location upon said fulfilling of said delivery of all of said online software order.

25. A system for distributing software via a network, the system comprising:
at least one processor that requests user identification utilized for tracking an online software order;
said at least one processor generates a pickup code associated with said online software order;
said at least one processor tracks downloads associated with said online software order based on at least one of said pickup code and an activation code; and
said at least one processor terminates said downloads upon fulfilling delivery of all of said online software order based on said tracking.

26. The system according to claim 1, wherein said at least one processor terminates delivery of at least a portion of said online software order, if said at least a portion of said online software order is not downloaded in a determined period of time.

27. The system according to claim 1, wherein said at least one processor suspends delivery of at least a portion of said online software order after receiving a suspension request.

28. The system according to claim 1, wherein said at least one processor maintains a delivery status of at least a portion of said online software order upon receiving a suspension request.

29. The system according to claim 1, wherein said at least one processor resumes delivery of at least a portion of said online software order upon receiving a resumption request.

30. The system according to claim 1, wherein said at least one processor receives said online software order, wherein said online software order comprises a quantity associated with at least one software item.

31. The system according to claim 1, wherein said at least one processor authorizes download of at least a portion of said online software order based on at least said pickup code.

32. The system according to claim 1, wherein said at least one processor adjusts a quantity of software items associated with said online software order after delivering at least one software item, which is a part of said online software order.

33. The system according to claim 1, wherein said at least one processor authorizes download of said online software order from a plurality of locations.

34. The system according to claim 1, wherein said at least one processor authorizes a subsequent download of a software item in said online software order if download of a portion of said online software order is failed.

35. The system according to claim 1, wherein said at least one processor generates said activation code upon initiation of delivery of at least a portion of said online software order.

36. The system according to claim 1, wherein said at least one processor terminates access to a secured download location upon said fulfilling of said delivery of all of said online software order.
